(19) United States
(12) Patent Application Publication
(10) Pub. No.: US 2005/0014513 A1
(43) Pub. Date: Jan. 20, 2005

(54) Method and a system for data transmission, and a device

(75) Inventors: Arto Mattila, Lempaala (FI); Petri Kokkonen, Espoo (FI)

Correspondence Address: Ware, Fressola, Van Der Sluys & Adolphson, LLP;Building Five, Bradford Green, 755 Main Street, P.O. Box 224, Monroe, CT, 06468, US

(73) Assignee: Nokia Corporation

(21) Appl. No.: 10/840,674

(22) Filed: May 6, 2004

(30) Foreign Application Priority Data
May 6, 2003 (FI) 20035060

(51) Int. Cl. H04Q 7/20; G11B 5/00

(52) U.S. Cl. 455/456.1

(57) ABSTRACT

The invention relates to a method for transmitting position data to a receiver, wherein a target whose position data is determined, as well as a receiver of position data are selected. The method comprises the steps of generating a request to determine position data, determining the position of the target, and transmitting the position data to the receiver. Information about the receiver is transmitted in connection with the request to determine position data. The message format available for the message to be transmitted to the receiver is determined, and a message complying with the determined message format is generated, to which the position data is added or included. The message including the position data is transmitted to the receiver. The invention also relates to a system, a device, and a computer program product in which the method is applied.

### CROSS-REFERENCE TO RELATED APPLICATIONS

This application claims priority under 35 USC §119 to Finnish Patent Application No. 20035060 filed on May 6, 2003.

### FIELD OF THE INVENTION

The present invention relates to a method for transmitting position data to a receiver, by selecting a target whose position data is to be determined, as well as a receiver for the position data, by forming a request to determine position data, by determining the position of the target, and by transmitting the position data to said receiver. The invention also relates to a system comprising a device with means for selecting a target, and means for generating a request to determine position data, means for determining the position of the target, and means for transmitting the position data to a receiver. Furthermore, the invention relates to a device comprising means for selecting a target, means for generating a request to determine position data and for transmitting it to the position determining means to determine the position of the target, and means for transmitting the position data to a receiver. Finally, the invention relates to a program and a storage means for storing the program, which program comprises machine-executable program instructions for transmitting position data to a receiver, for selecting a target whose position data is to be determined, for selecting a receiver for the position data, for generating a request to determine the position data, and for transmitting the position data to said receiver.

### BACKGROUND OF THE INVENTION

The significance and need of services and systems relating to determining and processing position data has recently increased to a great extent. Position data is of great assistance, for example, in various rescue service operations to provide aid to a correct target as soon as possible. For example, when an emergency call is made with a mobile phone, it is possible to try to determine the position of the mobile phone and to communicate it to the rescue party. In this case, the calling person does not necessarily need to know or try to find out his/her own position. Furthermore, the risk of misinterpreting the position possibly given by the calling person is significantly reduced. Also, for easy travelling, it is often advantageous to obtain position data of desired targets. Thus, the person may try to find out the locations of services, such as gas stations, restaurants, hotels, etc., on his/her route. This can be arranged, for example, by transmitting the position data of the person's mobile station as well as information about the services to be determined, etc., to a system. The system searches for services meeting the criteria, and if such are found, the system transmits information about these services and their locations. This information can be further displayed on the display of the mobile station. Yet another application to be mentioned is to inquire the position data of another person. In this case, the person transmits, for example to the mobile station of this second person, a request to transmit this position data to the first person's own mobile station. It is thus possible to determine the position of the second person's mobile station and to transmit the determined position data to the mobile station of the requesting person, unless it has been prevented.

It is obvious that the above-presented examples are only some non-limiting examples of applications utilizing position data.

Various methods are known for determining the position data of a target. For example, it is possible to use positioning receivers made for this purpose, which typically use a satellite positioning system to determine their own position. Also a base station based positioning system is known, wherein the position of a mobile station is determined by means of at least three different base stations either in such a way that the signals transmitted substantially simultaneously by these base stations are received at the mobile station, or in such a way that a signal transmitted by the mobile station is received by at least three base stations. In the base station based system, the position is to be computed on the basis of the reception time differences between the different signals. It is also possible that position data is stored in the system, for example in connection with services, wherein this stored position data can be used when the position data of such a service is requested.

In solutions of prior art, the position data are transmitted, for example, in the following way. In a device requesting for position data, an application designed for this purpose is executed to generate a request for position data, or the like. The position may be, for example, the device's own position, the position of a service, the position of another device, etc. This message is transmitted to a system in which the position data is determined in a suitable way, for example by satellite positioning. The system transmits the determined position data back to the device which requested it and in which the position data is transferred to the application. However, in many cases, this position data is not needed in the requesting device or application, but the position data must be transmitted further to another device and/or application. In this case, the application preferably determines where the position data is to be transmitted. When the receiver has been determined, the position data and the receiver data are transmitted further from the application. Thus, on the basis of the receiver data, the application must try to find out in which format the position data should be transmitted to the receiver. If the application can determine this, the application transmits the data e.g. via the software interface of the device to the operating system which transmits the data either to another application in the device, or from the device e.g. to a mobile communication network, to be transmitted further to the receiving device.

For the transmission of the position data, a large variety of alternatives is available, such as text message (SMS), multimedia message (MMS), e-mail, XML message, HTML message, XHTML message, WAP message, etc. Thus, the designer of the application should take into account these different transmission alternatives and the protocols used in them, if the application is to support their use in the transmission of the position data. This is an unwarranted step making it more difficult to design the application and complicating the structure of the application. Furthermore, the size of the application and the need for resources required in the operation are increased. Also, the circulation of the position data via the application that initiated the determination of the position data increases the need for data transmission.

### SUMMARY OF THE INVENTION

It is an aim of the present invention to provide an improved method and a system to be used for the transmission of position data to a receiver, as well as a device to be used in the system. The invention is based on the idea that the request to determine the position data is also supplemented with the data about the receiver to which the position data should be transmitted. In connection with the determination of the position data, the position data is transmitted to the receiver in such a format which is suitable for use in messages to be transmitted to the receiver in question. If necessary, the position data can also be transmitted to the device/application which started the determination. To put it more precisely, the method according to the present invention is primarily characterized in that the request to determine position data involves the steps of transmitting data about said receiver, determining the message format available for messages to be transmitted to the receiver, generating a message complying with the determined message format and supplementing it with the position data, and transmitting the message including the position data to the receiver. The system according to the present invention is primarily characterized in that the system also comprises means for transmitting data about said receiver in connection with the request to determine position data, determining means for determining the message format available for messages to be transmitted to the receiver, message generating means for generating a message complying with the determined message format, supplemented with the position data, and a transmitter for transmitting the message including the position data to the receiver. The device according to the present invention is primarily characterized in that the data about said receiver is arranged to be transmitted in connection with the request to determine position data, that the device also comprises determining means for determining the message format available for messages to be transmitted to the receiver, message generating means for generating a message complying with the determined message format, supplemented with the position data, and a transmitter for transmitting the message including the position data to the receiver. The program according to the present invention is primarily characterized in that the program also comprises program instructions for transmitting data about said receiver in connection with the request to determine position data, for determining the message format available for messages to be transmitted to the receiver, for generating a message complying with the determined message format, for supplementing said message with the position data, and for transmitting the message including the position data to the receiver. The storage means according to the present invention is primarily characterized in that the program also comprises program instructions for transmitting data about said receiver in connection with the request to determine position data, for determining the message format available for messages to be transmitted to the receiver, for generating a message complying with the determined message format, for supplementing said message with the position data, and for transmitting the message including the position data to the receiver.

The present invention shows advantages over solutions of prior art. In the system according to the invention, the position data does not need to be unnecessarily circulated via the device or software which requested for the determination of the position data, but the position data can be transmitted from the means for determining the position data directly to the intended receiver. Furthermore, the message to be used in the communication is formed, preferably in the position determining means, to comply with a message format supported by the receiver, wherein the device or software that requested for determining the position does not need to know the way/ways which is/are supported by the receiver or is otherwise most appropriate for the communication. Thus, the device/application that sent the request does not need to take care of protocol conversions, wherein the structure of the device/application becomes simpler and the operation requires less resources of the processor of the device. Also, the design of the applications to be executed in the device, requesting the position data, becomes simpler, because there is no need to take care of the processing of the received position data nor to the support of the different protocols, to convert the position data to a suitable format. Furthermore, in the system according to the invention, it is easier to introduce new protocols because the devices do not necessarily need to be upgraded but it is normally sufficient to upgrade that part of the system where the position data is converted to a message to be transmitted to the receiver.

### DESCRIPTION OF THE DRAWINGS

In the following, the present invention will be described in more detail with reference to the appended drawings, in which

FIG. 1 shows a system according to a preferred embodiment of the invention in a reduced chart,

FIG. 2 shows a device according to a preferred embodiment of the invention in a reduced block chart,

FIG. 3 shows the software configuration of the device according to an advantageous embodiment of the invention, in a reduced manner, for those parts necessary for the invention, and

FIG. 4 is a reduced chart showing the transmission of messages in the method according to an advantageous embodiment of the invention.

### DETAILED DESCRIPTION OF THE INVENTION

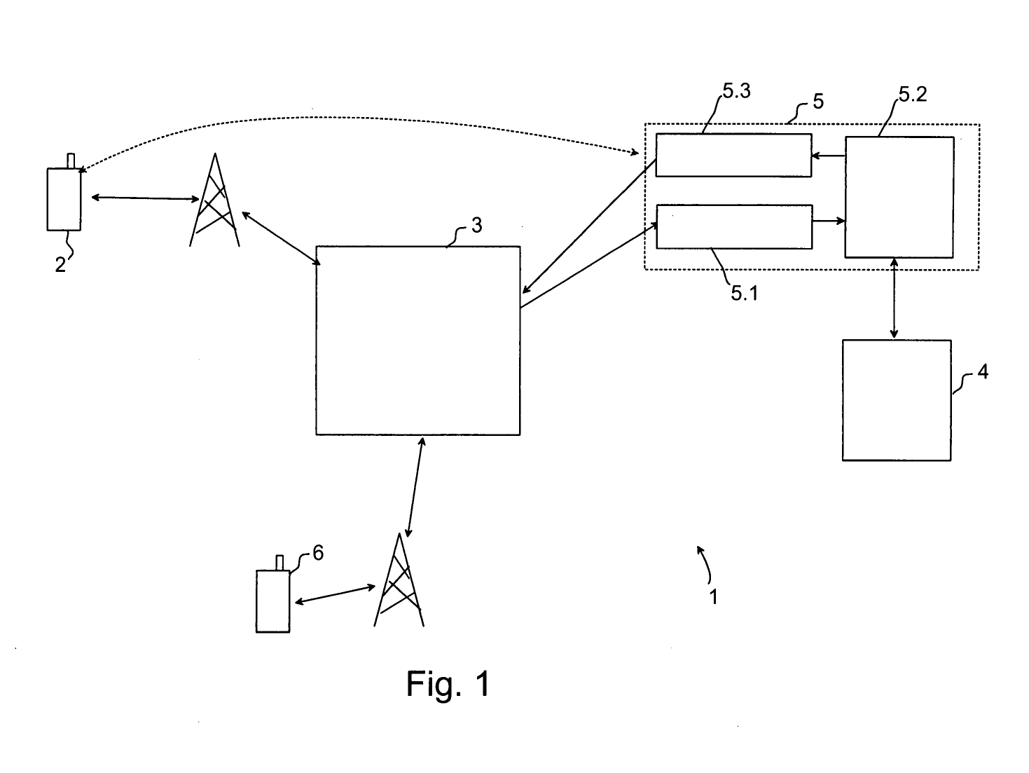

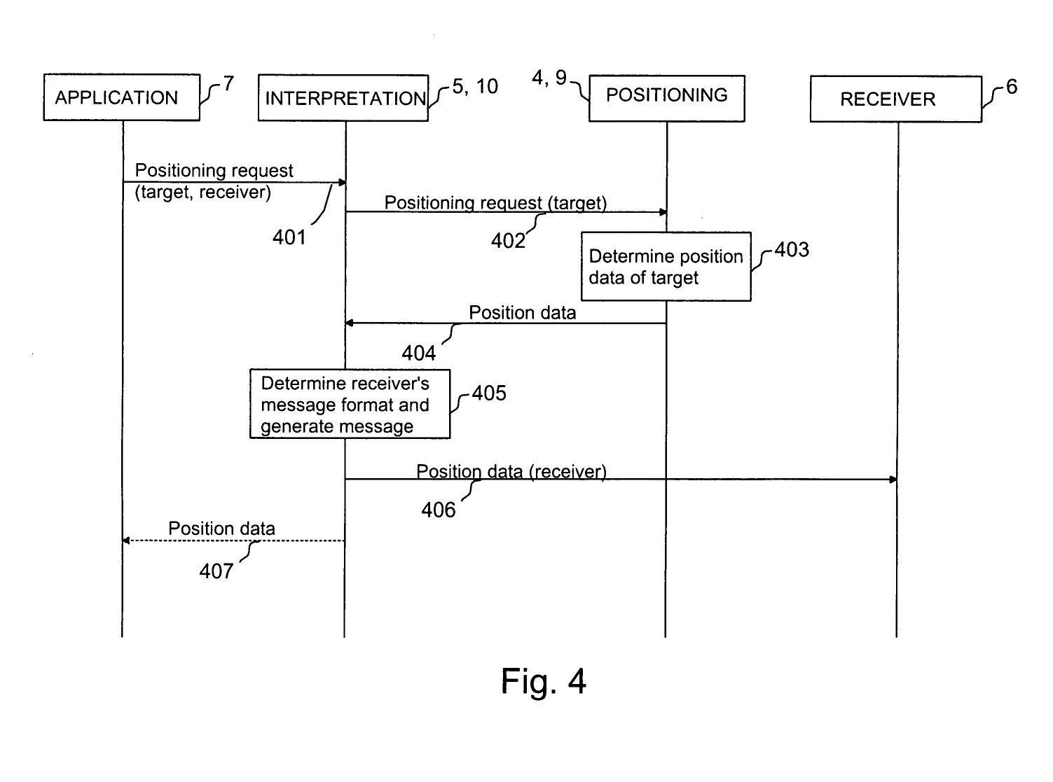

In the following, the operation of the method according to an advantageous embodiment of the invention will be described with reference to the system 1 of FIG. 1 and the chart of FIG. 4. The system comprises a user device 2, in which an application is executed, in which a request can be generated to determine position data. The requested position data may be the position of the device 2 itself, the position of another device, the position of a service point or the like, etc. In this advantageous embodiment, the system 1 comprises a data transmission network 3, such as a mobile communication network, via which the device 2 and the system can communicate. The system also comprises positioning means 4 for determining the position data.

The positioning means 4 may comprise, for example, satellite positioning means, positioning means based on base stations, or a database (not shown) where it is possible to store position data, determined in any way, of various targets, such as service points. However, it will be obvious that in view of the present invention, it is not essential how the position data is determined, wherein the above list of the positioning means must be interpreted as a non-limiting example only. Furthermore, the system comprises message processing means 5 with a receiver 5.1 for receiving a request for positioning data, interpreting means 5.2 for determining the message format available for messages to be transmitted to the receiver and for converting the position data to a message complying with such a message format, as well as a transmitter 5.3 to be used for the transmission of the position data from the positioning means 4 to the receiver 6. The receiver 6 may be an application in the device which transmitted the request, and/or another device, such as a mobile station. It should be noted that the chart of FIG. 1 represents a simplified illustration in which the different functions have been separated into logical entities. In practical applications, for example the positioning means 4 and/or the message transmission means 5 may be in whole or in part implemented in the device 2, or in whole or in part implemented in the data transmission network 3.

The device 2 comprises preferably at least a control block 2.1, a memory 2.2, communication means, such as a transmitter 2.3 and a receiver 2.4, and a user interface 2.5. The control block preferably comprises a processor (not shown) in a way known as such. The user interface typically comprises a display, a keypad, an earpiece, and a microphone.

Let us assume a situation in which an application is executed in the device 2, and the application 7 has a need to determine some position data. Thus, the application determines a receiver 6 for the position data, to which the position data should be transmitted. The application 7 sets up a position data request which includes information about the position (target) to be determined. Furthermore, the request is supplemented with information about said receiver. If the positioning means 4 are not located in connection with the device 2, the request is transmitted from the device 2 preferably via the data transmission network 3 to message processing means 5 (arrow 401 in FIG. 4).

The receiver 5.1 receives the message and transmits it to interpreting means 5.2 which interpret the received message. After it has been determined that the message is a request for position data, the first step is to find out the target whose position is to be determined, and the receiver. A request to determine the position of the target is transmitted (arrow 402) to the positioning means 4 which perform the positioning (block 403). If the positioning means 4 are implemented in connection with the device 2, a request or the like is transferred directly to the message processing means 5 in the device 2, where the message is received and interpreted, and the request to determine the position of the target is transferred to the positioning means 4 in connection with the device 2. In this alternative, the data transmission network 3 is not used for transmitting the request. If the position data can be determined by several different methods, the first step is to select the method to be used. On the other hand, the receiver of the request may have supplemented the request with information of which method can be used for determining the position data of the target. For example, if the target is the device 2 which transmitted the request, the positioning means 4 may thus perform the positioning e.g. by means of a satellite positioning system or by means of base stations. However, if the positioning means 4 comprise a database containing stored position data of various targets, the position of such a target can be determined by retrieving the position data of said target from the database.

The interpreting means 5.2 try to find out, from the receiver data, the message format in which the position data should be transmitted to the receiver (block 405). This determination may be based e.g. on the format in which the receiver data was transmitted to the interpreting means 5.2. The data can be, for example, the identification of a telecommunication terminal, such as IMEI (International Mobile Equipment Identity), the identification of a telecommunication service subscriber, such as a mobile phone number (e.g. MSISDN), an e-mail address (e.g. SMTP address), a receiving network address (e.g. IP address), a URL type address (Uniform Resource Locator), such as the address of a www page, a WAP address, or the like. In the case of a mobile phone number, it is possible to use e.g. text messages (SMS, Short Message Service) and/or multimedia messages (MMS, Multimedia Message Service), if the receiver's mobile station supports the reception of text messages and/or multimedia messages. In a corresponding manner, if the address is an e-mail address, it is possible to use e.g. a message complying with the SMTP protocol (Simple Mail Transfer Protocol), if this is supported by the e-mail system used. In connection with addresses of the URL type, for example HTML protocol, XML protocol, WAP protocol, or the like, may be available.

If some address format makes it possible to use more than one message formats (e.g. SMS or MMS above), it is possible, in the system according to an advantageous embodiment of the invention, to take the following steps. The interpreting device transmits, to the system indicated by the receiver's address, an inquiry of the message formats available to the receiver for receiving messages. For example in the mobile communication system, this can be, in some cases, determined on the basis of information included in the home location register (HLR, not shown in the appended drawings) or a profiling system (Device Profile). After this has been determined, the interpreting device may select the suitable message format.

The interpreting device 5.2 transmits (arrow 404) a message including the requested position data to the transmitter 5.3 which transmits the message to the receiver 6 (arrow 406). If necessary, the determined position data and/or the data about the successful/failed determination of the position data can also be transmitted to the device 2 which started the determination of the position (arrow 407).

Consequently, the message processing means 5 can also be implemented in the device 2 itself, wherein they can be implemented, for example, as services of the operating system of the device 2, or the like.

If necessary, the data is transmitted from the device 2 or application which started the determination of the position, to the message processing means 5, so that the position data and/or the data about the successful/failed determination of the position data can be transmitted to the correct target. If the operating system of the device 2 is equipped with the facility of a session-based API call, a session is normally set up between the application and the message processing means 5 (i.e. service) of the device, which session can be maintained for a given time. This session can be used for the transmission of the response information to the application.

In case the session mechanism is not used, the data must be determined in another way from the calling device 2 or application so that the response can be transmitted to the correct address.

In connection with the transmission of the position data, the receiver is also informed of the person or device whose position the position data represents. This data may be an individual identification, a pseudonym and/or a description of anonymity. For data security, the identification can be preferably selected such that it cannot be used to identify the target whose position data is in question.

When the position data is transmitted to the receiver, it is, in some cases, also possible to transmit information describing the quality of the position data in connection with the position data. Such information can be, for example, the accuracy/inaccuracy of the positioning. Particularly to secure individual protection, it is possible to determine, in the user settings of the transmitting device 2, whether quality information is to be transmitted or not. Thus, in the transmission of the position data to the receiver, the user settings of the transmitting device 2 are applied to decide about the transmission of quality information.

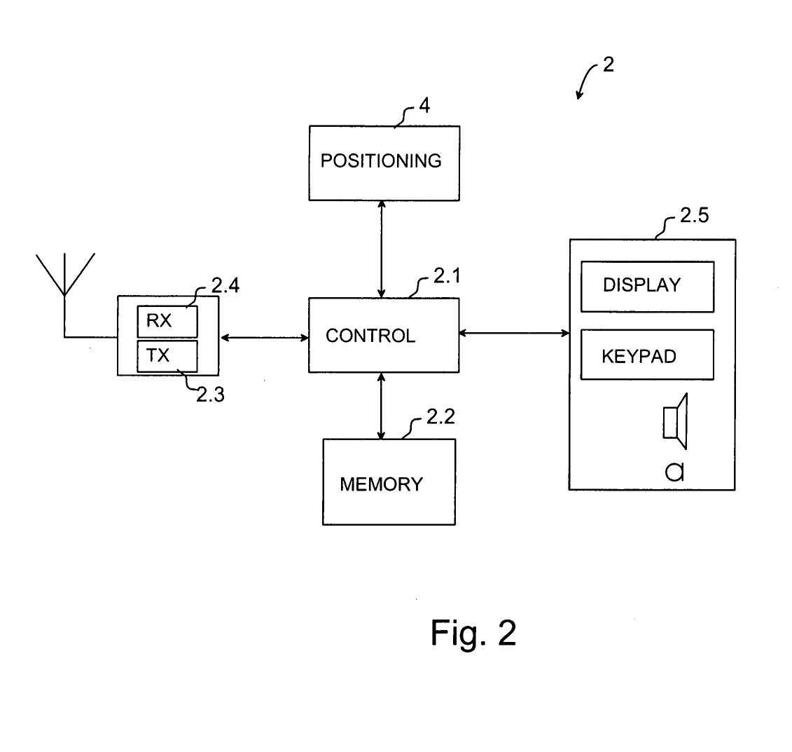

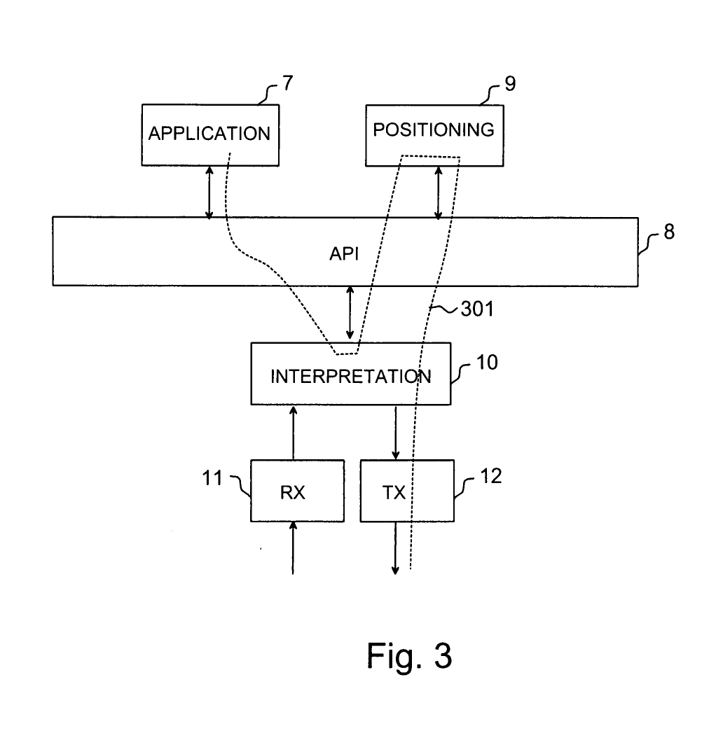

An example was described above, in which e.g. the message to be transmitted to the receiver is generated outside the device 2 requesting for position data. In the method according to another advantageous embodiment of the invention, the message processing device 5 are arranged in the device 2. In the following, the operation of this method will be described with reference to FIGS. 2 and 3. Arrow 301 indicates the procedure of the determination and the transmission of the position data in the device 2 in a reduced manner. The signalling chart of FIG. 4 can also be applied in this example. An application 7 being executed in the device 2 detects a need to determine the position of the device 2. Thus, the application generates a position data request or the like and transmits it (arrow 401 in FIG. 4) via an application programming interface (API) 8 preferably to an interpreting application 10. The interpreting application 10 transmits the positioning request and data about the target whose position is to be determined to a positioning application 9 (arrow 402). The positioning application 9 starts to execute positioning (block 403) either in the device itself or by using e.g. the data transmission network 3 (e.g. base station based/base station assisted positioning). The device 2 of FIG. 2 is provided with a positioning receiver 4, wherein in this case, the positioning data can be obtained from the positioning device 4, if this is possible under the conditions. In some cases, the position data determined by an earlier positioning may be stored in the device 2, wherein this data can be used as the position data, if necessary, or as a default position to accelerate the positioning of the device 2. As already mentioned above in this description, it is not significant in view of the present invention which method or combination of methods is used for the positioning.

In the positioning request (arrow 401), the application 7 preferably also transmits information about the receiver via the application programming interface 8 to the interpreting application 10 which analyzes the receiver data (block 405) e.g. to find out which message format can be used for the transmission of data to the receiver. Here, it is possible to apply the above principles, that is, for example, to examine the receiver's address type and make conclusions based on it. On the other hand, so-called address book records, which contain information about receivers, may have been stored in the device 2. In some cases, this information can also be supplemented with information about said message format used by the receiver.

The positioning application 9 transmits the position data (arrow 404) preferably to the interpreting application 10 which generates one or more messages to be transmitted to the receiver. When the message is ready for transmission, it is transferred (arrow 406) to the transmitter 2.3 to be transmitted to the data network. Also in this embodiment, the determined position data and/or the data about the successful/failed determination of the position data can also be transmitted, if necessary, to the device 6 which started the determination of the position (arrow 407).

FIG. 3 shows a receiving block 11 and a transmitting block 12 which are used, if necessary, for protocol conversions in a way known as such to compile messages of the physical layer to be transmitted to the data transmission network and to transfer received messages from lower layers to upper layers of the protocol stack (for example, physical layer→data link layer→network layer→application layer).

If the communication means of the device 2 do not support any message format also supported by the receiver 6, the following steps are preferably taken in an advantageous embodiment of the invention. The interpreting application 10 of the device 2 generates a message complying to the message format supported by the receiver, after which this message is framed to a message format which is available in the device 2. This message is transmitted to the data transmission network which comprises a conversion server or the like (not shown), in which the framed message can be separated and transmitted in the correct format to the receiver. An example to be mentioned is a situation in which the device 2 is a mobile station in which it is possible to transmit short messages but not SMTP messages. The conversion server breaks up, from the received short messages, the SMTP message formed by the interpreting application 10, and transmits it to the receiver's e-mail system.

The functions required by the method according to the invention can be implemented to a major extent by programming in the device 2 and/or in the message processing means 5 possibly provided in the system 1.

The position data can be supplemented to the transmission message 406 in different ways, depending e.g. on the message format used at the time. If the message format is http or wsp message, the position data is preferably supplemented by using a location attachment functionality defined in standards, such as the WAP standard 258, Chapter 24 Loc DTD (Location XML Document FormatsProposed Version 12-Sep.-2001, Wireless Application ProtocolWAP-258-LOCFORM-20010912-p).

It will be obvious that the present invention is not limited solely to the above-presented embodiments but it can be modified within the scope of the appended claims.

1. A method for transmitting position data to a receiver, comprising:
selecting a target whose position data is to be determined, as well as a receiver for the position data;
generating a request to determine position data;
transmitting data about said receiver in connection with said request;
determining the position of the target;
determining the message format available for messages to be transmitted to the receiver;
generating a message complying with the determined message format and provided with the position data; and
transmitting the message including the position data to the receiver.

2. The method according to claim 1, comprising performing the selection of the target in the device in which at least one application is being executed, wherein a positioning request supplemented with data about the receiver is transmitted by the application.

3. The method according to claim 2, comprising determining the message format available for messages to be transmitted to the receiver elsewhere than in said application which transmitted the positioning request.

4. The method according to claim 3, wherein the determined position data is left untransmitted to said application.

5. The method according to claim 1, comprising defining at least one address for the receiver; and determining the message format available for messages to be transmitted to the receiver on the basis of the format of an address defined for the receiver.

6. The method according to claim 1, comprising transmitting also other information in addition to said receiver data in connection with the positioning request.

7. The method according to claim 6, comprising using data about one or more methods available for determining the position of the target as said other information.

8. The method according to claim 1, comprising transmitting also other information in the message including the position data.

9. The method according to claim 8, wherein said other information comprises at least one of the following items:
information about the target whose position data is transmitted in said message, such as an individual identification, a pseudonym and/or an anonymity description of the target;
data about the quality of the position data, such as the accuracy/inaccuracy of the positioning.

10. A system comprising:
a device with means for selecting a target, and means for generating a request to determine position data;
means for determining the position of the target;
means for transmitting data about said receiver in connection with the request to determine position data;
determining means for determining the message format available in messages to be transmitted to the receiver;
message generating means for generating a message complying with the determined message format, supplemented with the position data; and
a transmitter for transmitting the message including the position data to the receiver.

11. The system according to claim 10, said device comprising means for executing at least one application, wherein a positioning request, supplemented with information about the receiver, is transmitted from the application.

12. The system according to claim 11, wherein said determining means are located elsewhere than in said application which transmitted the positioning request.

13. The system according to claim 10, wherein at least one address is defined for the receiver; and that the message format available for messages to be transmitted to the receiver is determined on the basis of the format of an address defined for the receiver.

14. The system according to claim 10, comprising positioning means; message interpreting means; and a data transmission network for the transmission of messages.

15. The system according to claim 14, wherein said positioning means and message interpreting means are separate from the device, wherein the positioning request is transmitted from the device to the positioning means; and the data about the receiver is transmitted to the interpreting means; and the determination of the message format available for messages to be transmitted to the receiver and the transmission of the position data to the receiver are performed in the interpreting means.

16. The system according to claim 14, wherein said device comprises said positioning means and message interpreting means, wherein the positioning request is transmitted from an application being executed in the device to the positioning means; and the data about the receiver is transmitted to the interpreting means; and that the determination of the message format available for messages to be transmitted to the receiver and the transmission of the position data to the receiver are performed in the interpreting means.

17. A device comprising:
means for selecting a target;
means for generating a request to determine position data and for transmitting it to positioning means to determine the position of the target;
means for transmitting the position data to a receiver, wherein the data about said receiver is transmitted in connection with the request to determine position data;
determining means for determining the message format available for messages to be transmitted to the receiver;
message generating means for generating a message complying with the determined message format and supplemented with the position data; and
a transmitter for transmitting the message including the position data to the receiver.

18. A program which comprises machine-executable program instructions for:
transmitting position data to a receiver;
selecting a target whose position data is to be determined;
selecting a receiver for the position data;
generating a request to determine position data;
transmitting data about said receiver in connection with the request to determine position data;
determining the position of the target;
determining the message format available for messages to be transmitted to the receiver;
generating a message complying with the determined message format;
including the position data in said message; and
transmitting the message including the position data to the receiver.

19. A storage means for storing a program, which program comprises machine-executable program instructions executable by a processor for:
transmitting position data to a receiver;
selecting a target whose position data is to be determined;
selecting a receiver for the position data;
generating a request to determine position data;
transmitting data about said receiver in connection with the request to determine position data;
determining the position of the target;
determining the message format available for messages to be transmitted to the receiver;
generating a message complying with the determined message format; including the position data in said message; and
transmitting the message including the position data to the receiver.
